(19) United States
(12) Patent Application Publication
(10) Pub. No.: US 2025/0114887 A1
(43) Pub. Date: Apr. 10, 2025

(54) METHOD FOR PROCESSING FRAMELESS SHELL MATERIALS

(71) Applicant: SHENZHEN FUTAIXIN TECHNOLOGY CO., LTD, SHENZHEN CITY (CN)

(72) Inventor: MIN LIN, SHENZHEN CITY, GUANGDONG PROVINCE (CN)

(21) Appl. No.: 18/795,197

(22) Filed: Aug. 6, 2024

(30) Foreign Application Priority Data
Oct. 10, 2023 (CN) 202311310033.1

(51) Int. Cl. B23P 23/04; B23P 25/00; C25D 5/00; C25D 5/44; C25D 11/04

(52) U.S. Cl. CPC B23P 23/04; B23P 25/00; C25D 5/44; C25D 5/623; C25D 11/04

(57) ABSTRACT

A method for processing frameless shell materials, relating to the technical field of mobile terminal device shell processing, is provided and includes the following steps: S1 cutting a sheet material, S2 stamping and curling, S3 CNC processing, S4 grinding and cleaning, S5 surface T processing, and S6. nano-injection molding. The present disclosure adopts a stamping method and replaces traditional metal block CNC processing, which can reduce production costs. During the stamping process, the aluminum sheet is edge-curled and thickened to enhance the strength of the shell material. By cutting a step-shaped groove for screen installation, a frameless design is achieved, thereby reducing production costs and assembly procedures. The anodizing of the U-shaped frame surface allows the plastic to fully penetrate the aluminum shell surface, thereby enhancing integration and preventing plastic parts from falling off the U-shaped frame.

### FIELD OF THE DISCLOSURE

The present disclosure relates to the technical field of mobile terminal device shell processing, specifically to a method for processing frameless shell materials.

### BACKGROUND OF THE DISCLOSURE

Mobile terminal device shells often use aluminum material. Traditional shell materials typically employ CNC to carve out the required shape from an aluminum block. On this basis, a face frame must be added to assemble the screen. As shown in FIG. 8, which is a schematic diagram of a mobile terminal device shell in existing technology, the mobile terminal device shell in existing technology uses CNC to carve out a U-shaped face frame from an aluminum block, and plastic face frames are installed on both sides of the top of the U-shaped face frame to mount the shell on the surface of the mobile terminal device, thus resulting in high production costs. Furthermore, because metal materials can shield signals, slots need to be opened, and antennas need to be drawn out by injection molding, usually by nano-injection molding. This process has the problem of injection molded parts easily falling off. Therefore, there is a need to propose a method for processing frameless shell materials.

### SUMMARY OF THE DISCLOSURE

The objective of the present disclosure is to provide a method for processing frameless shell materials, which has the advantages of reducing production costs, simplifying assembly procedures, and preventing plastic parts from falling off the surface of the U-shaped frame, thereby solving the problems presented in the background technology.

In order to achieve aforementioned purpose, the present disclosure provides a method for processing frameless shell materials, comprising the following steps: Step 1, cutting a sheet material: pre-cutting an aluminum sheet into a basic shape for processing a frameless shell material for later use; Step 2, stamping and curling: stamping the cut sheet material by using a stamping machine, and during the stamping process, thickening a frame and curling the frame into an inner U-shaped frame; Step 3, CNC processing: creating an antenna groove on a surface of the U-shaped frame and creating a step structure for installing a screen on the U-shaped frame; Step 4, grinding and cleaning: cleaning burrs and dirt on the surface of the U-shaped frame; Step 5, surface T processing: oxidizing the surface of the U-shaped frame to form micro-pores on the surface of the U-shaped frame; and Step 6, nano-injection molding: nano-injection molding the antenna groove and other plastic parts on the surface of the U-shaped frame.

Preferably, S1 cutting a sheet material comprises the following steps: Step 101, determining a required size and shape that needs to be cut out of the aluminum sheet according to design requirements of a mobile terminal device shell; Step 102, folding the aluminum sheet into the required shape by using a folding machine; Step 103, cutting the aluminum sheet by using an aluminum sheet cutting tool according to the design requirements; and Step 104, unfolding the aluminum sheet along a cutting direction and trimming an edge of the aluminum sheet to achieve a required smoothness and surface quality.

Preferably, in the step 103, when cutting the aluminum sheet, the cutting is performed on a front side of the aluminum sheet and the aluminum sheet is cut down along a contour of the aluminum sheet cutting tool.

Preferably, in the step 2, stamping and curling: stamping the cut sheet material by using a stamping machine comprises the following steps: Step 201, placing the cut aluminum sheet in a lower chamber of the stamping machine, and pressing an upper die of the stamping machine down to stamp the aluminum sheet, so that the aluminum sheet is stretched and thinned, and an edge of the aluminum sheet forms a thicker edge; in the step 202, after stamping the aluminum sheet into a U-shaped frame, using two sets of push blades on the stamping machine to press both sides of the U-shaped frame to make tops of both sides of the U-shaped frame to form inwardly recessed curls; and in the step 203, pushing the U-shaped frame out of the lower chamber after stamping.

Preferably, in the step 3, CNC processing comprises the following steps: Step 301, milling a rubber member receiving groove: using a three-axis CNC to process an inner surface of an injection molded shell material, wherein a processed outer shape is a XY base surface of a post-process, and an outer shape tolerance is +0.05 to −0.03 mm; Step 302, milling a line groove: using a three-axis CNC to process a front feature of the injection molded shell material; Step 303, milling an outer shape and a camera feature: using a three-axis CNC to refine the outer shape and the camera feature of the shell material; Step 304, milling an inner cavity for avoidance: using a three-axis CNC to process the inner cavity of the shell material to achieve a flatness of 0.15; Step 305, milling a side hole on a short edge: using a four-axis CNC to process the side hole on the short edge of the shell material, and wherein during the processing, a large flat magnetic stone clamp is used to position an internal shape of the shell material; Step 306, milling a side hole on a long edge: using a four-axis CNC to process the side hole on the long edge of the shell material, and wherein during the processing, a large flat magnetic stone clamp is used to position an internal shape of the shell material; and Step 307, highlight processing: using a three-axis CNC to process upper and lower C-angle highlights of the shell material.

Preferably, in the step 4, grinding and cleaning the U-shaped frame comprises the following steps: Step 401, surface cleaning: using a high-pressure air gun to blow off dust and debris from the surface of the U-shaped frame; Step 402, applying a cleaning agent: applying a cleaning agent to a portion of the U-shaped frame where burrs and dirt exist, specifically using a sodium hydroxide solution; and Step 403, surface cleaning: after applying the cleaning agent, using a flowing water rinse to clean the burrs and dirt from the surface of the U-shaped frame to remove cleaning agent residues and grease.

Preferably, after cleaning the burrs and dirt from the surface of the U-shaped frame in the step 4, an alkaline cleaning agent is used to clean the surface of the U-shaped frame again to remove any remaining oxide layer and paint.

Preferably, in the step 5, surface T processing of the U-shaped frame comprises the following steps: Step 501, in a high-temperature vacuum environment, on the surface of the U-shaped frame, reacting oxide with an interface between aluminum and the oxide to generate aluminum oxide and zinc oxide; Step 502, under a room temperature heating condition, aluminum oxide and zinc oxide undergoing a secondary reaction on the surface of the U-shaped frame to form micro-pores; Step 503, controlling size and shape of the micro-pores by controlling an oxidation process; and Step 504, electroplating the U-shaped frame to protect the micro-pores on the surface, so as to prevent aluminum oxide and zinc oxide from further reacting with aluminum and oxide.

Preferably, in the step 503, controlling the oxidation process comprises the following aspects: controlling size and shape of the micro-pores by changing an oxidation temperature, while a lower oxidation temperature results in smaller micro-pores, and while a higher oxidation temperature leads to larger micro-pores; controlling size and shape of the micro-pores by changing an oxidation time, while a longer oxidation time results in smaller micro-pores, and while a shorter oxidation time leads to larger micro-pores; and controlling size and shape of the micro-pores by changing an oxidation atmosphere, wherein carrying out oxidation treatment in normal air produces larger micro-pores, while carrying out oxidation treatment under a vacuum condition primarily produces aluminum oxide and results in smaller micro-pores.

Preferably, in the step 6, nano-injection molding specifically comprises the following steps: Step 601, cleaning impurities, oil stains, and oxides on the surface of the U-shaped frame to ensure that the surface of the U-shaped frame is clean; Step 602, polishing the surface of the U-shaped frame before nano-injection molding to help the surface better adhere to an injection molding material; Step 603, selecting polyurethane as the injection molding material according to the shape of the U-shaped frame; Step 604, using pressure injection to evenly fill the surface of the U-shaped frame with the injection molding material; Step 605, cooling the injection molding material on the surface of the U-shaped frame after injection molding to fully bond the injection molding material to the U-shaped frame; and Step 606, inspecting whether the injection molding material has leakage, bubbles and wrinkles to test a nano-injection molding effect on the surface of the U-shaped frame, and if there is any problem, repairing or re-injecting the material.

Compared with existing technology, the beneficial effects of the present disclosure are as follows.

The present disclosure adopts a stamping method to replace the traditional CNC machining of metal blocks, thereby reducing production costs. During the stamping process, the aluminum sheet is flanged and thickened to enhance strength of the shell material, and a step-shaped groove for screen installation is cut out to achieve a frameless design that reduces production costs and simplifies assembly procedures. The surface of the U-shaped frame is anodized to allow the plastic to fully penetrate the surface of the aluminum shell, thereby enhancing the integration and preventing the plastic parts from falling off the U-shaped frame.

### BRIEF DESCRIPTION OF THE DRAWINGS

FIG. 1 is a flowchart of the method for processing frameless shell materials in an embodiment of the present disclosure.

FIG. 2 is a flowchart of cutting the sheet material in the embodiment of the present disclosure.

FIG. 3 is a flowchart of stamping and curling the aluminum sheet in the embodiment of the present disclosure.

FIG. 4 is a flowchart of CNC processing in the embodiment of the present disclosure.

FIG. 5 is a flowchart of grinding and cleaning the U-shaped frame in the embodiment of the present disclosure.

FIG. 6 is a flowchart of T surface processing for the U-shaped frame in the embodiment of the present disclosure.

FIG. 7 is a flowchart of nano-injection molding in the embodiment of the present disclosure.

FIG. 8 is a structural diagram of a mobile terminal device shell in the prior art.

FIG. 9 is a structural diagram of the U-shaped frame in the embodiment of the present disclosure.

### DETAILED DESCRIPTION OF THE EXEMPLARY EMBODIMENTS

The present disclosure will be described clearly and completely in conjunction with the accompanying drawings in the embodiments of the present disclosure. The described embodiments are only part of the embodiments of the present disclosure, not all of them. Based on the described embodiments of the present disclosure, all other embodiments obtained by those skilled in the art without making creative efforts shall fall within the protection scope of the present disclosure.

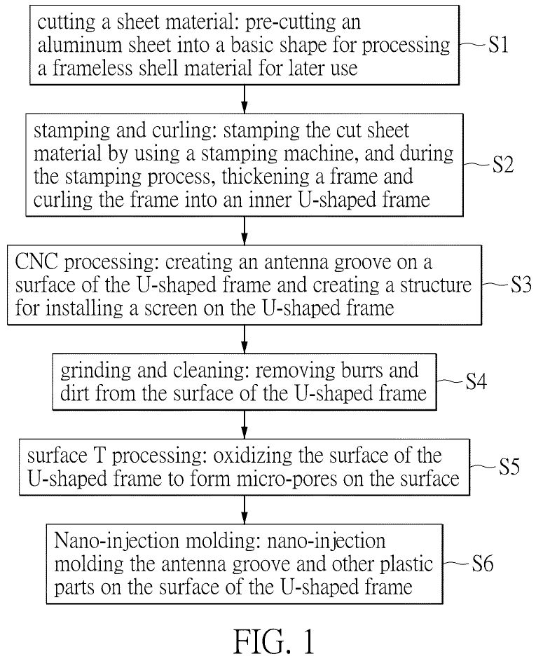

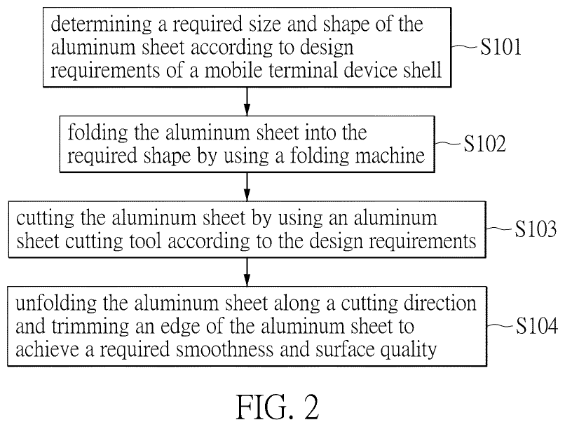

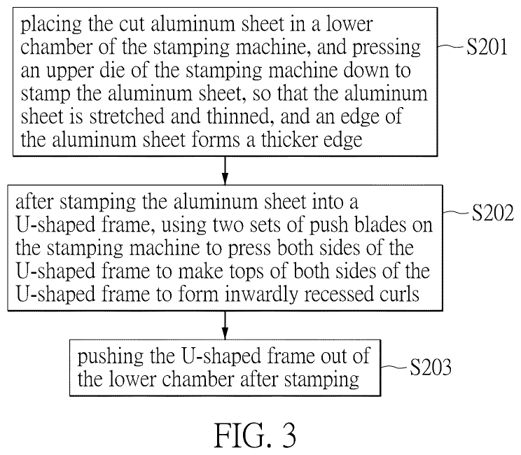

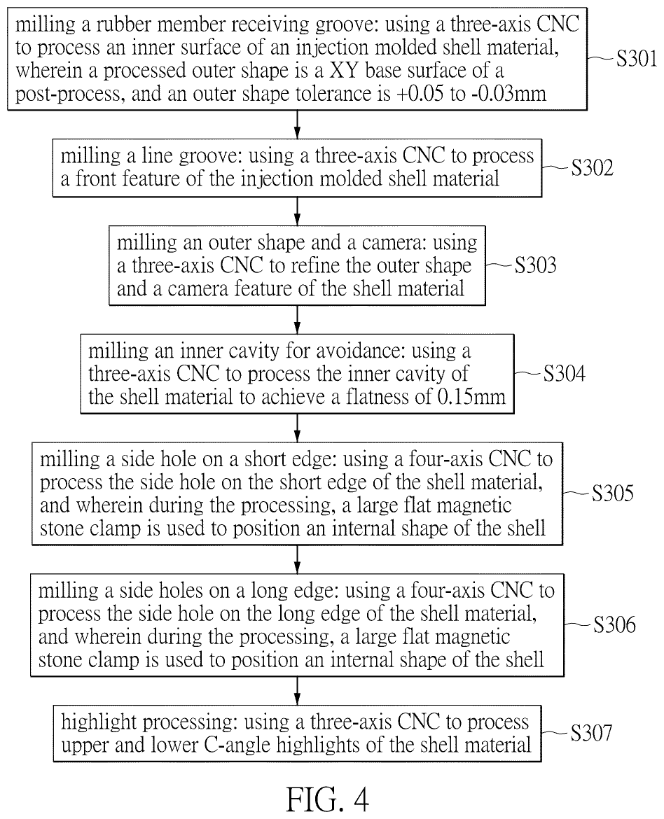

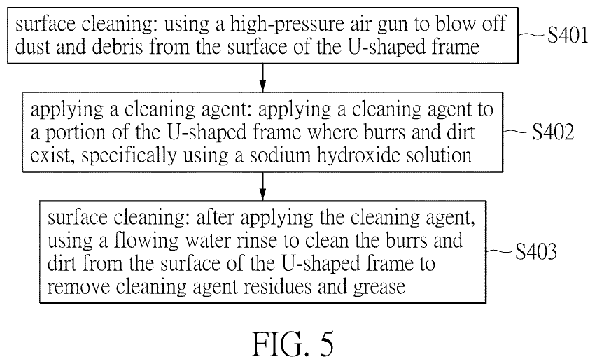

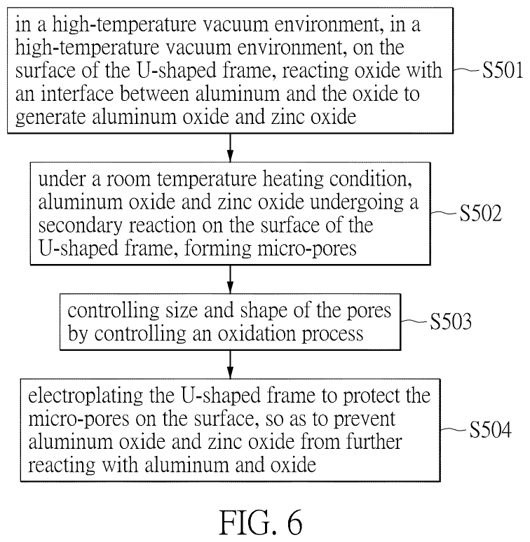

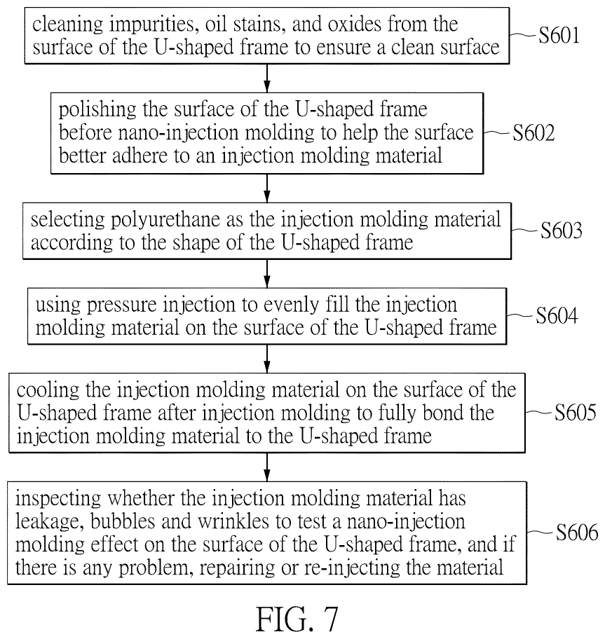

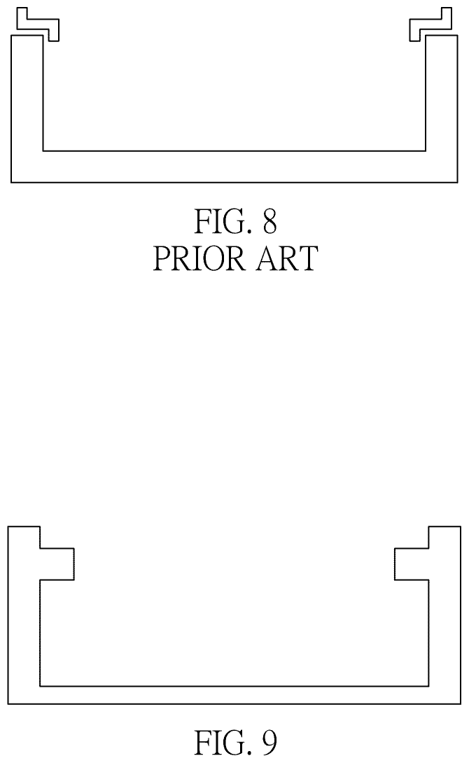

Please refer to FIGS. 1-7. The present disclosure provides a method for processing frameless shell materials, including the following steps.

Step 1 (S1), cutting a sheet material: pre-cutting an aluminum sheet into a basic shape for processing a frameless shell material.

Specifically, S1 includes the following steps.

Step 101 (S101), determining a required size and shape that needs to be cut of the aluminum sheet according to design requirements of a mobile terminal device shell.

Step 102 (S102), folding the aluminum sheet into the required shape by using a folding machine.

Step 103 (S103), cutting the aluminum sheet by using an aluminum sheet cutting tool according to the design requirements.

Step 104 (S104) unfolding the aluminum sheet along a cutting direction and trimming an edge of the aluminum sheet to achieve a required smoothness and surface quality.

Further, in S103, when cutting the aluminum sheet, the cutting is performed on a front side of the aluminum sheet and the aluminum sheet is cut down along a contour of the aluminum sheet cutting tool.

Step 2 (S2), stamping and curling: stamping the cut sheet material by using a stamping machine, and during the stamping process, thickening a frame and curling the frame into an inner U-shaped frame.

Specifically, S2 includes the following steps.

Step 201 (S201), placing the cut aluminum sheet in a lower chamber of the stamping machine, and pressing an upper die of the stamping machine down to stamp the aluminum sheet, so that the aluminum sheet is stretched and thinned, and an edge of the aluminum sheet forms a thicker edge.

Step 202 (S202), after stamping the aluminum sheet into a U-shaped frame, using two sets of push blades on the stamping machine to press both sides of the U-shaped frame to make tops of both sides of the U-shaped frame to form inwardly recessed curls.

Step 203 (S203), pushing the U-shaped frame out of the lower chamber after stamping.

S3 CNC processing: creating an antenna groove on a surface of the U-shaped frame and creating a step structure for installing a screen on the U-shaped outer frame.

Specifically, S3 includes the following steps:

Step 301 (S301), milling a rubber member receiving groove: using a three-axis CNC to process an inner surface of an injection molded shell material, wherein a processed outer shape is an XY base surface of a post-process, and an outer shape tolerance is +0.05 to −0.03 mm.

Step 302 (S302), milling a line groove: using a three-axis CNC to process a front feature of the injection molded shell material.

Step 303 (S303), milling an outer shape and a camera: using a three-axis CNC to refine the outer shape and a camera feature of the shell material.

Step 304 (S304), milling an inner cavity for avoidance: using a three-axis CNC to process the inner cavity of the shell material to achieve a flatness of 0.15 mm.

Step 305 (S305), milling a side hole on a short edge: using a four-axis CNC to process the side hole on the short edge of the shell material, and wherein during the processing, a large flat magnetic stone clamp is used to position an internal shape of the shell material.

Step 306 (S306), milling a side hole on a long edge: using a four-axis CNC to process the side hole on the long edge of the shell material, and wherein during the processing, a large flat magnetic stone clamp is used to position an internal shape of the shell material.

Step 307 (S307) highlight processing: using a three-axis CNC to process upper and lower C-angle highlights of the shell material.

Step 4 (S4) grinding and cleaning: removing burrs and dirt from the surface of the U-shaped frame.

Specifically, S4 includes the following steps:

Step 401 (S401), surface cleaning: using a high-pressure air gun to blow off dust and debris from the surface of the U-shaped frame.

Step 402 (S402), applying a cleaning agent: applying a cleaning agent to a portion of the U-shaped frame where burrs and dirt exist, specifically using a sodium hydroxide solution.

Step 403 (S403), surface cleaning: after applying the cleaning agent, using a flowing water rinse to clean the burrs and dirt from the surface of the U-shaped frame to remove cleaning agent residues and grease.

Further, after cleaning the burrs and dirt from the surface of the U-shaped frame in S4, an alkaline cleaning agent is used to clean the surface of the U-shaped frame again to remove any remaining oxide layer and paint.

Step 5 (S5) surface T processing: oxidizing the surface of the U-shaped frame to form micro-pores on the surface of the U-shaped frame.

Specifically, S5 includes the following steps.

Step 501 (S501) in a high-temperature vacuum environment, on the surface of the U-shaped frame, reacting oxide with an interface between aluminum and the oxide to generate aluminum oxide and zinc oxide.

Step 502 (S502) under a room temperature heating condition, aluminum oxide and zinc oxide undergoing a secondary reaction on the surface of the U-shaped frame to form micro-pores.

Step 503 (S503) controlling size and shape of the micro-pores by controlling an oxidation process.

Step 504 (S504) electroplating the U-shaped frame to protect the micro-pores on the surface, so as to prevent aluminum oxide and zinc oxide from further reacting with aluminum and oxide.

Further, controlling the oxidation process in S503 includes the following aspects:
controlling size and shape of the micro-pores by changing an oxidation temperature, while a lower oxidation temperature results in smaller micro-pores, and while a higher oxidation temperature leads to larger micro-pores, so that sizes of the micro-pores are controlled by modifying the oxidation temperature;
controlling size and shape of the micro-pores by changing an oxidation time, while a longer oxidation time results in smaller micro-pores, and while a shorter oxidation time leads to larger micro-pores, so that sizes of the micro-pores are controlled by modifying the oxidation time;
controlling size and shape of the micro-pores by changing an oxidation atmosphere, wherein carrying out oxidation treatment in normal air produces larger micro-pores, while carrying out oxidation treatment under a vacuum condition primarily produces aluminum oxide and results in smaller micro-pores, so that sizes of the micro-pores are controlled by modifying the oxidation atmosphere.

Furthermore, the size and shape of the micro-pores can be controlled by changing the type of oxide. The type and content of oxides in the micro-pores will also affect the size and shape of the micro-pores. For example, when the oxidation treatment is carried out in air, the content of aluminum oxide is higher, which can produce larger micro-pores; when the oxidation treatment is carried out under a vacuum condition it mainly produces aluminum oxide, which can produce smaller micro-pores. Therefore, the size and shape of the micro-pores can be controlled by adjusting the type and content of oxides.

In other embodiments, an aluminum shell anodizing method based on nano-molding processing is used to oxidize the U-shaped frame. The specific steps include the following steps:
performing foaming processing on the aluminum shell that has been treated by nano molding technology and subjected to in-mold injection molding at a temperature of 90±2° C.
anodizing the foamed aluminum shell by using a voltage of 14V to 20V for 16 to 24 minutes.
sealing the anodized aluminum shell at a temperature of 85 to 100° C. for 8 to 12 minutes.

In the aluminum shell anodizing method based on nano-molding processing, the aluminum shell undergoes sandblasting before the foaming processing, and the sandblasting is conducted by using a pressure range of 19.61 to 23.54 Newtons.

In the aluminum shell anodizing method based on nano-molding processing, after sandblasting, the aluminum shell is immersed in a water tank containing 6% to 12% neutral degreasing agent for 6 to 10 minutes to degrease.

In the aluminum shell anodizing method based on nano-molding processing, after the foaming processing, the aluminum shell is neutralized at a room temperature for 8 to 12 seconds and then washed with deionized water.

In the aluminum shell anodizing method based on nano-molding processing, during the deionized water cleaning process, compressed air is introduced into the deionized water.

In the aluminum shell anodizing method based on nano-molding processing, the anodized aluminum shell undergoes a dyeing process before sealing, and the dyeing is carried out at a temperature between 45 and 65° C. for 2.5 to 4.5 minutes.

In the aluminum shell anodizing method based on nano-molding processing, after the sealing process, the aluminum shell is washed and then dried under a temperature between 80° C. and 100° C. for 8 to 12 minutes.

In the aluminum shell anodizing method based on nano-molding processing, the foaming processing uses 98% sulfuric acid, and the foaming duration is set between 8 to 12 seconds.

In the aluminum shell anodizing method based on nano-molding processing, the anodization of the aluminum shell is conducted at a temperature between 16° C. and 24° C.

In the aluminum shell anodizing method based on nano-molding processing provided by the embodiment, by means of innovative improvements to the anodization process of the NMT aluminum shell, while ensuring the surface quality of the aluminum shell, the destructive impact of the anodization process on the adhesion strength of the NMT aluminum shell can be significantly reduced, such that the plastic structure and metal surface still retain a relatively practical bonding force after surface treatment, thereby creating favorable conditions for the popularization and application of the NMT aluminum shell in smartphones.

Step 6 (S6), Nano-injection molding: nano-injection molding the antenna groove and other plastic parts on the surface of the U-shaped frame; wherein nano-injection molding on the surface of aluminum products is a technology that fuses materials with the aluminum surface, which can provide aluminum products with higher strength, hardness and wear resistance. Specifically, S6 nano-injection molding comprises the following steps:

Step 601 (S601), cleaning impurities, oil stains, and oxides from the surface of the U-shaped frame to ensure that the surface of the U-shaped frame is clean.

Step 602 (S602), polishing the surface of the U-shaped frame before nano-injection molding to help the surface better adhere to an injection molding material.

Step 603 (S603), selecting polyurethane as the injection molding material according to the shape of the U-shaped frame.

Step 604 (S604), using pressure injection to evenly fill the surface of the U-shaped frame with the injection molding material.

Step 605 (S605), cooling the injection molding material on the surface of the U-shaped frame after injection molding to fully bond the injection molding material to the U-shaped frame.

Step 606 (S606), inspecting whether the injection molding material has leakage, bubbles and wrinkles to test a nano-injection molding effect on the surface of the U-shaped frame, and if there is any problem, repairing or re-injecting the material.

As depicted in FIG. 9, the diagram shows the structure of a mobile device shell processed by using the present disclosure. The shell utilizes stamping instead of traditional CNC machining of metal blocks, so as to reduce production costs. During the stamping process, the aluminum sheet is curled and thickened at the edges to enhance strength of the shell and cut out a step-shaped groove for screen installation, thereby achieving a frameless design and also reducing both production costs and assembly steps. The anodized U-shaped frame allows plastic to permeate fully into the surface of the aluminum shell, thereby enhancing integration and preventing plastic parts from detaching from the U-shaped frame.

Although embodiments of the present disclosure have been shown and described, it will be understood by those skilled in the art that various changes, modifications, substitutions, and alterations can be made without departing from the principles and spirit of the present disclosure. The scope of the present disclosure is defined by the appended claims and their equivalents.

What is claimed is:

1. A method for processing frameless shell materials, comprising the following steps:
Step 1, cutting a sheet material: pre-cutting an aluminum sheet into a basic shape for processing a frameless shell material for later use;
Step 2, stamping and curling: stamping the cut sheet material by using a stamping machine, and during the stamping process, thickening a frame and curling the frame into an inner U-shaped frame;
Step 3, CNC processing: creating an antenna groove on a surface of the U-shaped frame and creating a step structure for installing a screen on the U-shaped frame;
Step 4, grinding and cleaning: cleaning burrs and dirt on the surface of the U-shaped frame;
Step 5, surface T processing: oxidizing the surface of the U-shaped frame to form micro-pores on the surface of the U-shaped frame; and
Step 6, nano-injection molding: nano-injection molding the antenna groove and other plastic parts on the surface of the U-shaped frame.

2. The method according to claim 1, wherein in the step 1, the cutting a sheet material includes the following steps:
Step 101, determining a required size and shape that need to be cut of the aluminum sheet according to design requirements of a mobile terminal device shell;
Step 102, folding the aluminum sheet into the required shape by using a folding machine;
Step 103, cutting the aluminum sheet by using an aluminum sheet cutting tool according to the design requirements; and
Step 104, unfolding the aluminum sheet along a cutting direction and trimming an edge of the aluminum sheet to achieve a required smoothness and surface quality.

3. The method according to claim 2, wherein in the step 103, when cutting the aluminum sheet, the cutting is performed on a front side of the aluminum sheet and the aluminum sheet is cut down along a contour of the aluminum sheet cutting tool.

4. The method according to claim 3, wherein in the step 2, stamping and curling: stamping the cut sheet material by using a stamping machine includes the following steps:
Step 201, placing the cut aluminum sheet in a lower chamber of the stamping machine, and pressing an upper die of the stamping machine down to stamp the aluminum sheet, so that the aluminum sheet is stretched and thinned, and an edge of the aluminum sheet forms a thicker edge;
Step 202, after stamping the aluminum sheet into a U-shaped frame, using two sets of push blades on the stamping machine to press both sides of the U-shaped frame to make tops of both sides of the U-shaped frame to form inwardly recessed curls; and
Step 203, pushing the U-shaped frame out of the lower chamber after stamping.

5. The method according to claim 4, wherein in the step 3, CNC processing comprises the following steps:
Step 301, milling a rubber member receiving groove: using a three-axis CNC to process an inner surface of an injection molded shell material, wherein a processed outer shape is a XY base surface of a post-process, and an outer shape tolerance is +0.05 to −0.03 mm;
Step 302, milling a line groove: using a three-axis CNC to process a front feature of the injection molded shell material;
Step 303, milling the outer shape and a camera feature: using a three-axis CNC to refine the outer shape and the camera feature of the shell material;
Step 304, milling an inner cavity for avoidance: using a three-axis CNC to process the inner cavity of the shell material to achieve a flatness of 0.15 mm;
Step 305, milling a side hole on a short edge: using a four-axis CNC to process the side hole on the short edge of the shell material, and wherein during the processing, a large flat magnetic stone clamp is used to position an internal shape of the shell material;
Step 306, milling a side hole on a long edge: using a four-axis CNC to process the side hole on the long edge of the shell material, and wherein during the processing, a large flat magnetic stone clamp is used to position an internal shape of the shell material; and
Step 307, highlight processing: using a three-axis CNC to process upper and lower C-angle highlights of the shell material.

6. The method according to claim 5, wherein in the step 4, grinding and cleaning the U-shaped frame comprises the following steps:
Step 401, surface cleaning: using a high-pressure air gun to blow off dust and debris from the surface of the U-shaped frame;
Step 402, applying a cleaning agent: applying a cleaning agent to a portion of the U-shaped frame where burrs and dirt exist, specifically using a sodium hydroxide solution; and
Step 403, surface cleaning: after applying the cleaning agent, using a flowing water rinse to clean the burrs and dirt from the surface of the U-shaped frame to remove cleaning agent residues and grease.

7. The method according to claim 6, wherein after cleaning the burrs and dirt from the surface of the U-shaped frame in the step 4, an alkaline cleaning agent is used to clean the surface of the U-shaped frame again to remove any remaining oxide layer and paint.

8. The method according to claim 7, wherein in the step 5, surface T processing of the U-shaped frame comprises the following steps:
Step 501, in a high-temperature vacuum environment, on the surface of the U-shaped frame, reacting oxide with an interface between aluminum and the oxide to generate aluminum oxide and zinc oxide;
Step 502, under a room temperature heating condition, aluminum oxide and zinc oxide undergoing a secondary reaction on the surface of the U-shaped frame to form micro-pores;
Step 503, controlling size and shape of the micro-pores by controlling an oxidation process; and
Step 504, electroplating the U-shaped frame to protect the micro-pores on the surface, so as to prevent aluminum oxide and zinc oxide from further reacting with aluminum and oxide.

9. The method according to claim 8, wherein in the step 503, controlling the oxidation process comprises the following aspects:
controlling size and shape of the micro-pores by changing an oxidation temperature, wherein, a lower oxidation temperature results in smaller micro-pores, and a higher oxidation temperature leads to larger micro-pores;
controlling size and shape of the micro-pores by changing an oxidation time, wherein, a longer oxidation time results in smaller micro-pores, and a shorter oxidation time leads to larger micro-pores; and
controlling size and shape of the micro-pores by changing an oxidation atmosphere, wherein, carrying out oxidation treatment in normal air produces larger micro-pores, and carrying out oxidation treatment under a vacuum condition primarily produces aluminum oxide and results in smaller micro-pores.

10. The method according to claim 9, wherein in the step 6, nano-injection molding specifically comprises the following steps:
S601, cleaning impurities, oil stains, and oxides on the surface of the U-shaped frame to ensure that the surface of the U-shaped frame is clean;
S602, polishing the surface of the U-shaped frame before nano-injection molding to help the surface better adhere to an injection molding material;
Step 603, selecting polyurethane as the injection molding material according to the shape of the U-shaped frame;
Step 604, using pressure injection to evenly fill the surface of the U-shaped frame with the injection molding material;
Step 605, cooling the injection molding material on the surface of the U-shaped frame after injection molding to fully bond the injection molding material to the U-shaped frame; and
Step 606, inspecting whether the injection molding material has leakage, bubbles and wrinkles to test a nano-injection molding effect on the surface of the U-shaped frame, and if there is any problem, repairing or re-injecting the material.
